(19) United States
(12) Patent Application Publication
(10) Pub. No.: US 2005/0098447 A1
(43) Pub. Date: May 12, 2005

(54) Gas sensor with controller, and system and method for employing same

(76) Inventors: Stephen H. Broy, Riverside, CA (US); Dennis M. Antieau, Duarte, CA (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/706,625

(22) Filed: Nov. 12, 2003

(51) Int. Cl. G01N 27/26

(52) U.S. Cl. 205/775; 204/401; 204/424

(57) ABSTRACT

A gas sensor comprising a housing including a cavity and an anode within the cavity. The gas sensor further includes a controller in communication with the anode and configured to measure sensor current output. A method and system of employing the gas sensor is also disclosed.

### BACKGROUND

1. Field of the Invention

This invention relates to an improved gas sensor, and more particularly to a gas sensor in communication with a controller, and a system and method for employing the same.

2. Brief Description of the Background

FIG. 1 illustrates a typical oxygen sensor 110 such as, for example, Teledyne Analytical Instruments' R17 sold by Teledyne Instruments-Analytical Instruments, City of Industry, Calif. The oxygen sensor 110 consists of a cathode 102 and an anode 104 sealed in a housing 106 filled with appropriate electrolyte solution. Oxygen diffuses into the interior of the sensor housing 106 through a thin sensing membrane 108. A flexible expansion membrane 112 at the opposite end of the sensor 110 permits expansion or contraction of the electrolyte volume. The sensing membrane 108 is sealed in place by means of press fit or heat seal. The expansion membrane 112 is sealed in place by means of heat or mechanical seal. Reduction of oxygen at the cathode 102 causes current to flow from the cathode 102 to the anode 104 through an externally connected sensing circuit (not shown).

Present demands on gas analyzers require that the gas sensors that they employ, such as the R17 model described above, effectively and continuously measure concentrations of gas from an incoming stream. For example, some trace oxygen monitoring systems require the near continuous measurement of oxygen gas in a gaseous stream in amounts at or below several hundred parts per million. Other high percent level gas sensors measure much higher levels of oxygen content. Regardless of the type of sensor employed, the gas sensor must be extremely sensitive to gas concentrations to provide accurate oxygen content.

As illustrated in FIGS. 2-3, in some prior art sensors, a clamp portion 125 engages the sensor 110 to seal the electrolyte solution in the interior of the housing 106 so that the sensor 110 may be oriented in a cavity portion of the cell block for installation into the analyzer 130. The cell block exposes the sensor to a sample gas stream, and provides hermetic electrical connections to the cathode 102, anode 104, and other necessary electrical terminals of the sensor 110. As the sensor 110 measures the incoming gas stream for low levels of oxygen, the anode 104, typically formed of lead, is consumed at a rate dictated by the exposure of the sensor 110 to oxygen.

Because the anode 104 is sealed within the sensor housing 106 and its degree of consumption cannot be visually monitored, full consumption of the anode 104 may occur at inconvenient or unexpected times in the gas measuring process. Accordingly, users typically take preventative measures to avoid gas sensor failure and undue delay in the gas monitoring process. For example, the user may employ a preventative replacement scheme that provides replacement of the sensor 110 at regularly scheduled time intervals usually well in advance of the full consumption of the anode 104. In addition, or as an alternative, the user may utilize an inline backup analyzer, if employed, or a backup sensor that is capable of immediately measuring the gas stream with the required accuracy when the original gas sensor fails. Both of these options have relatively high associated costs. Accordingly, the user of present commercial gas sensors must either implement relatively costly preventative methods or risk delays due to unexpected gas sensor failure that may inhibit the effective and continuous use of the analyzer.

Accordingly, the need exists for an improved gas sensor that provides consistency of replacement from sensor to sensor, limits the premature replacement of parts, and/or reduces the cost of preventative measures or the potential for extended periods of process downtime as a result of the anode being consumed at inconvenient or unexpected times.

### SUMMARY

The present invention addresses one or more of the above-mentioned needs by providing a gas sensor comprising a housing including a cavity and an anode within the cavity. The gas sensor further includes a controller in communication with the anode and configured to measure sensor current output.

In another embodiment, the present invention is directed to a gas sensor comprising a housing including a cavity. The housing includes an anode within the cavity. The gas sensor further includes a controller in communication with the anode and configured to measure sensor current output and determine the remaining life of the anode. The gas sensor also includes an analog to digital converter in communication with the controller and a display that is configured to display the remaining life of the sensor.

The present invention is additionally directed to a gas sensor comprising a housing including a cavity. The housing includes an anode within the cavity. A means for measuring sensor current output at the anode and determining the remaining life of the sensor is also included.

In another embodiment, the present invention is directed to a system for determining the remaining life of a gas sensor, comprising a housing, a controller, and a host system. The housing includes a cavity and an anode within the cavity. The controller is in communication with the anode and configured to measure sensor current output. The host system is in communication with the controller and configured to receive data output from the controller.

The present invention is also directed to a method of determining the remaining life of a gas sensor. The method includes measuring sensor current output by a controller, and subtracting the measured current output from a theoretical total current output to determine the remaining life of the sensor.

It should be understood that this invention is not limited to the embodiments disclosed in this Summary, and it is intended to cover modifications that are within the spirit and scope of the invention, as defined by the claims.

### BRIEF DESCRIPTION OF THE SEVERAL VIEWS OF THE DRAWING

The characteristics and advantages of the present invention may be better understood by reference to the accompanying drawings, wherein like reference numerals designate like elements and in which:

FIG. 1 is a cross-sectional view of a prior art gas sensor;

FIG. 2 is a cross-sectional view of the prior art gas sensor of FIG. 1 sealed by a clamp portion;

FIG. 3 is a cross-sectional view of the prior art gas sensor of FIG. 1 installed into a conventional gas sensor (cell) block analyzer;

FIG. 4 is a cross-sectional view of one embodiment of the gas sensor of the present invention in the form of an oxygen sensor and illustrates the arrangement of the embodiment's individual components;

FIG. 5 is an elevational view of the gas sensor of FIG. 4 in a first configuration coupled to a monitor and displaying the remaining life of the sensor;

FIG. 6 is an elevational view of the gas sensor of FIG. 4 in a second configuration coupled to a monitor and displaying the remaining life of the sensor and other sensor data output;

FIG. 7 is an elevational view of the gas sensor of FIG. 4 in a third configuration coupled to a monitor and displaying the remaining life of the sensor;

FIG. 8 is an elevational view of the gas sensor of FIG. 4 in a fourth configuration coupled to a monitor and displaying the remaining life of the sensor and other sensor data output;

FIG. 9 is an elevational view of the gas sensor of FIG. 4 in a fifth configuration displaying the remaining life of the sensor; and

FIG. 10 is an elevational view of the gas sensor of FIG. 4 in a sixth configuration displaying the remaining life of the sensor.

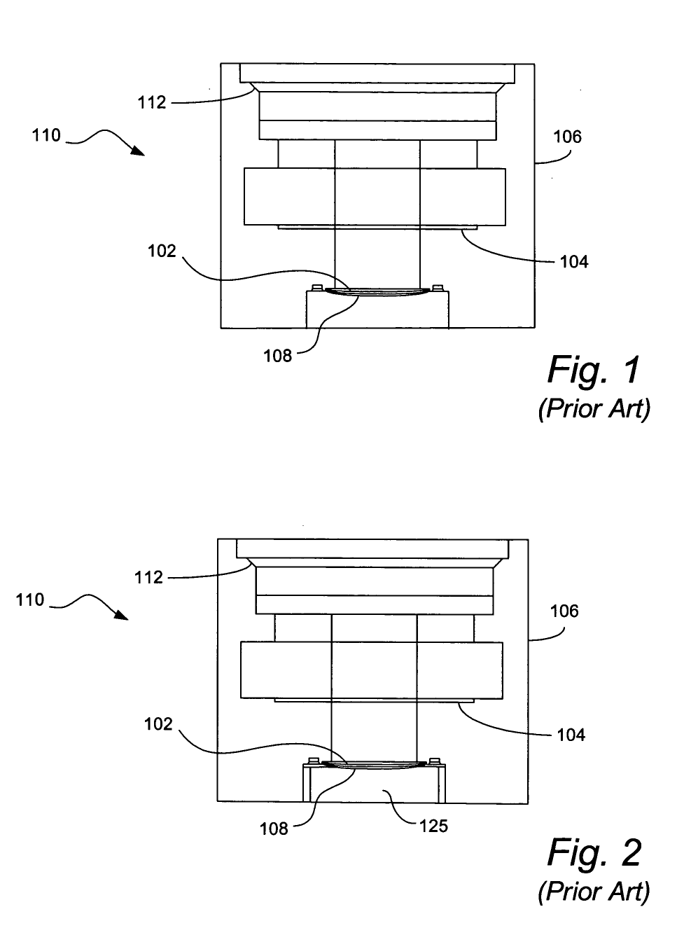

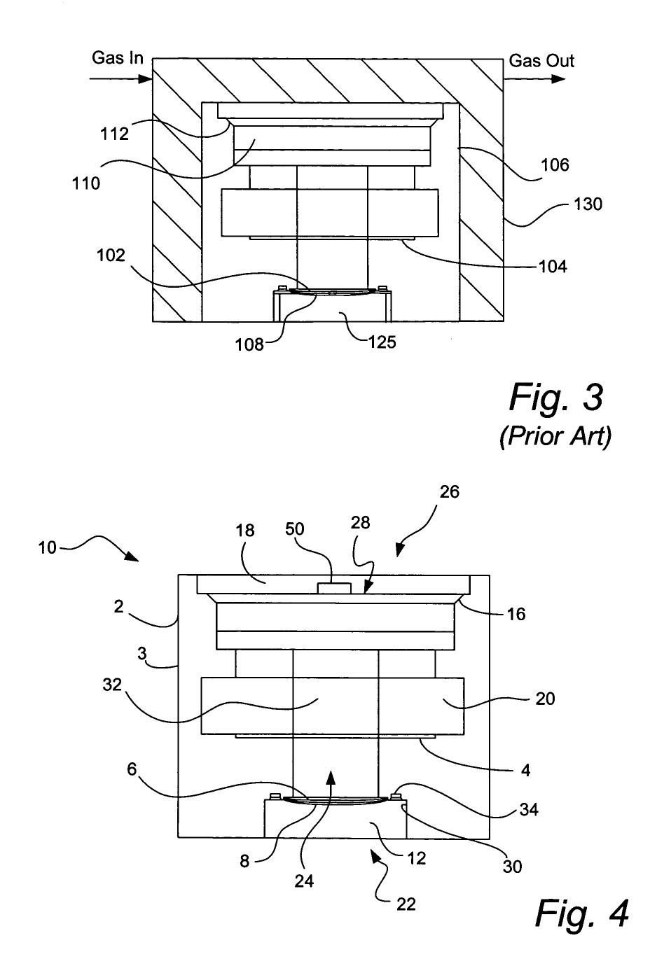

### DETAILED DESCRIPTION OF EMBODIMENTS OF THE INVENTION

In the present detailed description of the invention, the invention will be illustrated in the form of a gas sensor adapted for use as a sealed galvanic oxygen sensor. It will be understood, however, that the invention is not limited to embodiment in such form and may have application in any gas sensor. For example, the sensor may be in the form of a trace gas sensor, such as those that may be employed in a cell block for analysis, or may be in the form of a high percent gas sensor that is typically employed for analysis without a cell block. Thus, while the present invention is capable of embodiment in many different forms, for ease of description this detailed description and the accompanying drawings disclose only specific forms as examples of the invention. Those having ordinary skill in the relevant art will be able to adapt the invention to application in other forms not specifically presented herein based upon the present description.

Also, for ease of description, the invention and devices to which it may be attached may be described and/or illustrated herein in a normal operating position, and terms such as upper, lower, front, back, horizontal, proximal, distal, etc., may be used with reference to the normal operating position of the referenced device or element. It will be understood, however, that the apparatus of the invention may be manufactured, stored, transported, used, and sold in orientations other than those described and/or illustrated.

Other than in the operating examples, or unless otherwise expressly specified, all of the numerical ranges, amounts, values and percentages such as those for amounts of materials, and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

In addition, for ease of description, the terms “anode” and cathode” are used herein to refer to the electrodes of the present invention. It will be understood that the terms “anode” and “cathode” are used herein to refer, generally, to the electrodes of the present invention and, in particular, are used to refer to electrodes that may be incorporated as components of an oxygen sensor. It will be understood that the invention has applicability to gas sensors including electrodes identified as other than anodes and cathodes. For example, as is known in the art, other types of gas sensors may incorporate electrodes in the forms of a “sensing” or “working” electrode (the cathode) and a counter electrode (the anode), as well as reference electrode(s). The terms “anode” and “cathode”, as used herein, are intended to include these other types of electrodes.

Typical galvanic oxygen sensors consist, in part, of a machined plastic body filled with electrolyte solution, a cathode (working electrode) manufactured from perforated sheet metal such as brass and plated with an appropriate noble metal such as, for example, rhodium, gold, or silver, and an anode (counter electrode) formed of any anode material such as, for example, compressed lead pellets. The electrolyte solution may be potassium hydroxide. A gaseous stream enters the body by diffusing through a synthetic membrane positioned at an inlet and is transported through a thin electrolyte layer to the cathode. The oxygen is reduced to hydroxyl ions at the cathode. Simultaneously, anode material, such as lead, is continually oxidized at the anode. Thus, the following electrochemical reactions occur at the cathode and the lead anode:
Cathode: O₂+2H₂O+4e⁻→4OH⁻
Anode: 2Pb→2Pb²⁺+4e⁻

Lead oxide formed, though soluble in the potassium hydroxide electrolyte initially, will eventually deposit on the lead anode as the electrolyte becomes saturated with lead ions. When the cathode and the anode are electrically connected external to a circuit, an ionic current flows through the sensor. The current is proportional to the rate of oxygen consumption. In embodiments of the present invention, the ionic current generated by the sensor is measured by an electronic device, such as a controller, described herein. Connection between external sensing circuitry and the cathode is typically achieved by welding a small diameter (typically 0.01 inch) silver wire to the cathode. Connection between the same external sensing circuitry and the anode is accomplished by compressing (sintering) lead pellets around a small coil of nickel wire in an attempt to maximize the contact surface area between the wire and the lead particles.

Referring now to the drawings, which are for the purpose of illustrating embodiments of the invention and not for the purpose of limiting the same, FIG. 4 depicts an embodiment of a gas sensor constructed according to the present invention and in the form of an oxygen sensor 10. As will be apparent from the following description, the sensor 10 improves upon the construction of the known gas sensors with respect to at least the ability to measure and provide the user notice of the anticipated remaining life of the sensor 10. The sensor 10 may include a housing 2, an anode 4, a cathode 6, a sensing membrane 8, a clamp 12, a controller 50, an expansion or back membrane 16, and a printed circuit board 18.

The housing 2 may be an open-ended cylinder that comprises an anode cavity 20 defined by an internal wall of the housing 2. The housing 2 may be a single formed component or may be separately formed components that are secured together by any known method such as, for example, heat sealing, welding, or press fit. All components that form the housing 2 may be formed separately or as a single unit through processes such as, for example, pouring or injection molding. The housing 2 may be fabricated from, for example, any resilient insulating material, including, for example, a thermoplastic material such as, for example, polyethylene. The housing 2 may be any shape or configuration, such as, for example, a cylindrical body with the internal and external walls being generally coaxial, as illustrated. The housing 2 may have any suitable dimensions. For example, as incorporated in oxygen sensor 10, the housing 2 may have a longitudinal length of 1.25 inches and a diameter of 1.2 inches. Other housing dimensions will follow from the application for which the sensor 10 is adapted.

The housing 2 may include a first end 22 defining a first opening 24 and a second end 26 defining a second opening 28. The first opening 24 receives the entering stream of gas to be sensed. The first opening 24 may be any size or shape suitable for receiving the gaseous stream. For example, the opening 24 may have a circular cross section and have a diameter of 0.9 inches. As illustrated, the first opening 24 may be located within a recessed portion 30 of the first end 22 and may be centrally spaced relative to the external wall 3 of the housing 2. The recessed portion 30 may be any size and geometry, such as, for example, a cylindrical cavity having a diameter of 0.7 inches that is centrally spaced from the external wall 3 of the housing 2. The height of the recessed portion 30 may be substantially equal to the total thickness of the clamp 12, described herein, so that an outer surface of the clamp 12 may be substantially flush with an inner edge of the housing 2 after being placed within the recessed portion 30 of the housing 2 and secured thereto.

The second opening 28 of the housing 2 may be positioned opposite the first opening 24 and may be defined by the external wall 3 of the housing 2. The second opening 28 may be any size or geometry suitable for receiving the back membrane 16 and printed circuit board 18, such as, for example, a circular cross section having a diameter of 1.0 inch that is centrally positioned relative to the external wall 3 of the housing 2. The height of the second opening 28 may be substantially equal to the total thickness of the back membrane 16 and the printed circuit board 18 so that a surface of the printed circuit board 18 may be substantially flush with an edge of the housing 2 after being placed over the back membrane 16 and sealed thereto to complete the back portion of the sensor 10.

The internal wall of the housing 2 defines an open ended passage 32 that extends into the housing 2 to form the anode cavity 20, thereby providing fluid communication to the electrolyte in the anode cavity 20 for the gases entering the first opening 24. The length of the internal wall may define the passage 32 and may have any suitable longitudinal length. In one embodiment, the longitudinal length of the internal wall is 0.9 inches. It will be understood that the anode cavity 20 may be any chamber defined by the interior dimensions of the housing 2. The anode cavity 20 may be any suitable size and geometry known in the art for containing an amount of electrolyte sufficient for the effective measurement of the entering gaseous stream.

The anode 4 may be formed of any electrically conductive anode material, such as, for example, lead. As adapted for use in sensor 10, the anode 4 may be a solid lead body formed of sintered lead pellets, or may be in the form of a lead wire. The anode 4 may be positioned in the anode cavity 20 in any known manner, such as for example, over or around the internal wall that forms the passage 32 that leads to the anode cavity 20. It will be understood that the anode 4 may be fabricated in a variety of ways, such as, for example, by stamping a flat pattern from a sheet of an electrically conductive metal. The anode 4 may be electrically connected to external circuitry by, for example, compressed (sintered) pellets around a small coil of silver wire to measure the electrical current produced by the electrochemical reaction occurring at the anode 4.

The cathode 6 may be a concave disc-like member formed of any cathode material known in the art. The cathode 6 may be constructed of, for example, a noble metal such as silver, or a substrate plated with, for example, silver or rhodium. As provided in sensor 10, the cathode 6 may include a concave base having a diameter of 0.9 inches and thickness of 0.01 inches. The cathode base may include a curved contact surface that may be, for example, concave relative to the anode cavity 20 when assembled, and that includes a number of small, perforated holes therethrough (not shown). Although those skilled in the art may, upon considering the present disclosure, readily appreciate numerous ways to form the cathode 6, the cathode 6 may be manufactured by photo-chemically etching a flat pattern of the cathode 6 from a sheet of any suitable material, such as, for example, nickel or brass. The cathode 6 may then be shaped to include a concave surface, as illustrated, by using one or more of a variety of methods including, for example, the use of a progressive die. The cathode 6 may then be plated with an appropriate cathode material, such as, for example, rhodium, gold or silver. The cathode 6 is electrically connected to external circuitry by, for example, welding a small diameter (typically 0.01 inch) silver wire to the cathode 6 to measure the electrical current produced by the electrochemical reaction occurring at the cathode 6.

The sensing membrane 8 may be positioned adjacent to and in contact with the cathode 6, as illustrated. The sensing membrane 8 may be constructed of any of the various types of hydrophobic, gas permeable materials known in the art. For example, as incorporated in sensor 10, the sensing membrane 8 may be formed of a Teflon® film. The permeability of the material is such that gas may pass therethrough, but electrolyte solution will not.

The second opening 28 may be sealed with a back membrane 16 that allows for expansion or contraction of the electrolyte volume. The back membrane 16 may be any suitable resilient material, such as a thermoplastic, including polyethylene. The back membrane 16 may be sealed to the housing 2 by any means known in the art, but in sensor 10 the back membrane 16 may be thermally sealed to the housing 6.

When present, the clamp 12 may be any clamp known to those skilled in the art for effectively retaining the cathode 6 and the sensing membrane 8 in close association with each other and together to provide a positive seal at the first opening 24 of the housing 2. The clamp 12 may be concave relative to the first opening 24 and may include a central woven mesh portion as known in the art that protects the cathode 6. The clamp 12 may be sized for receipt in the recessed portion 30 of the first end 22 and secured therein by any engagement means known in the art. For example, as incorporated into sensor 10, the clamp 12 may be fastened over the first opening 24, the cathode 6, and the sensing membrane 8 by threaded fasteners 34. The positive locking action achieved by the fasteners 34 provides the pressure required to effectively seal the sensing membrane 8 to the housing 2 over the first opening 24. The clamp 12 may be constructed of, for example, an elastomer or thermoplastic material that produces sufficient pressure against the sensing membrane 8 and housing 2 to create an effective seal.

The sensor 10 of the present invention may further include a controller 50, such as a microprocessor or microcontroller, in communication with the anode 4. The controller 50 may be configured to automatically measure sensor output current from the anode 4 to determine the estimated remaining life of the sensor 10, as described herein. As used herein, when referring to the output current as being “measured” by the controller 50, it is contemplated that the output current may be measured directly or indirectly. For example, output current may be calculated (i.e. measured indirectly) through the measurement of voltage across the resistor/thermistor network and integrated in any desired units, such as, for example, ampere-hours, to determine the remaining life of the sensor 10. The controller 50 may be in communication with the anode 4 by any means known in the art. For example, the controller 50 may be electrically connected to the anode 4 by, for example, a low voltage conductive wire that is suitable for measuring the output current generated by the anode 4. Although the controller 50 may be positioned at any location suitable for measuring the current output of the sensor 10, the controller 50 may be positioned inside the sensor housing 2, and may, but need not, be positioned on the printed circuit board 18, as illustrated. Although any suitable controller 50 may be employed with the gas sensor 10 of the present invention, in one embodiment, the present invention may employ a microcontroller commercially sold as Model PIC16F88 by Microchip Technology, Inc., Chandler Ariz.

The controller 50 may be employed with a board analog to digital (A/D) converter, as known in the art, and powered by a power supply, such as a battery, to measure and transmit the sensor current output as described herein. The A/D converter may, but need not, be an on-board converter and may, but need not, be integral to the controller 50. The controller 50 may measure the sensor current output from the anode 4 continually or intermittently. As the sensor 10 is continually exposed to oxygen, the cumulative oxygen exposure consumes the lead anode 4 at a rate dictated by the exposure of the sensor 10 to oxygen thereby producing a current output.

The controller 50 may be configured to integrate the total output current of the sensor 10 over time and subtract this cumulative total from a predetermined theoretical total to determine the remaining life of the anode 4 and, hence, the gas sensor 10. The theoretical total represents the total cumulative output current of a typical unused gas sensor and may be a fixed starting point pre-programmed into the controller 50 based on the particular sensor 10 employed. The theoretical output total may vary depending on the sensor model employed, and may be determined based on numerous manufacturer or independent tests performed and experimental data collected that accurately and reliably estimate the life of a typical gas sensor of that model, represented in the form of, for example, ampere-hours. The cumulative total output of the sensor 10, as measured or calculated by the controller 50, may be subtracted from this theoretical total output to predict, in real time, and with good accuracy the remaining life of the sensor 10.

By way of example only, and without intending to limit the scope of the claims, for the R17 sensor set forth above, it has been determined with good accuracy that the average sensor life of the R17 sensor, as determined by the depletion of the anode, is 4.0 ampere-hours. Accordingly, at an initial Time 0, typically measured at the initial start-up of the sensor 10 and at the time when the sensor 10 initially begins to generate an output current, the system of the present invention, via the controller 50, may process and transmit the initial starting point as the remaining life of the sensor (4.0 ampere-hours). Thereafter, at a later Time x, as the sensor 10 is exposed to oxygen and is producing an output current, the controller 50 can calculate the total cumulative current produced by the sensor 10 (x), typically in ampere-hours, and subtract this amount from the theoretical total at Time 0 (4.0−x) to determine the remaining life of the anode 4, and, thus, the sensor 10. The controller 50 may be configured to process the remaining life of the sensor 10 until the counter reaches a zero value.

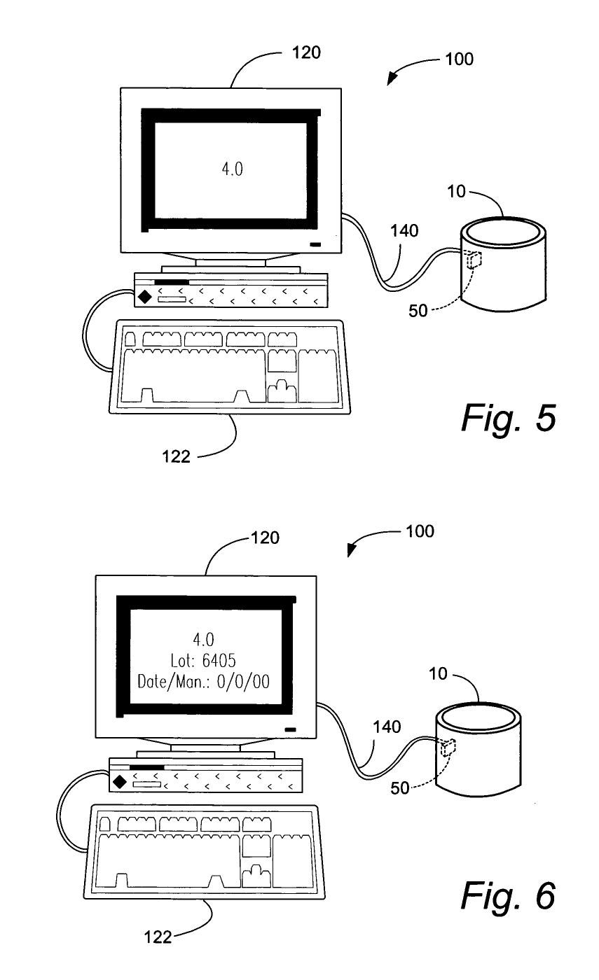

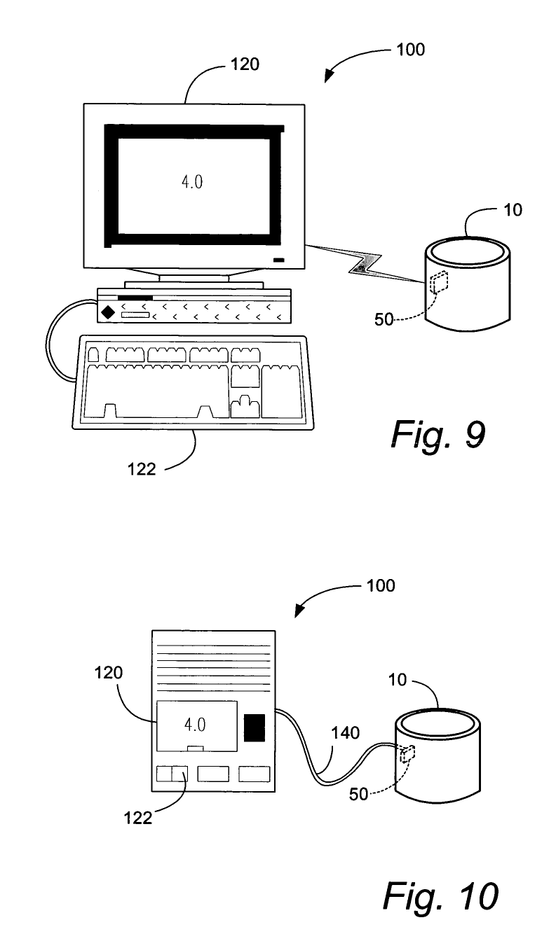

FIGS. 5-10 illustrate embodiments of the gas monitoring system of the present invention. For clarity, FIGS. 5-10 show the sensor 10 larger than actual size to illustrate the relevant features of the system of the present invention, but do not show known or optional gas sensor analysis components, such as the analyzer, that may be employed or that are unnecessary to explain the operation of the present invention. As illustrated, the controller 50 may be configured to communicate the data output derived from the sensor 10 to a host system 100. The controller 50 may be in communication with the host system 100 by any suitable means. For example, the controller may be in communication with the host system electrical connection, such as through external circuitry 140, as illustrated in FIGS. 5-8 and 10, or through wireless communication, as illustrated in FIG. 9. The external circuitry 140 may be welded to the board on which the controller 50 is positioned. When the controller 50 includes external circuitry 140 that engages the host system 100, the host system 100 may include a connection member, such as a serial port present in a conventional personal computer, for receipt of the external circuitry 140. Alternatively, as illustrated in FIG. 9, the controller 50 may communicate with the host system 100 by any form of wireless communication known to those of skill in the art. The data output may be communicated to the host system 100 in encrypted format to prevent machine tampering and unauthorized parts substitution, as well as normalize the analog output with standard ranges convenient to the user. For example, the controller 50 may control a digital to analog (D/A) converter that may normalize the sensor output to a standard range, such as a range of 0 to 1 V, or 0 to 10 mV.

In addition to the remaining sensor life described above, it is contemplated that the controller 50 may be configured to process and digitally communicate other data in addition to the remaining life of the gas sensor. For example, and as illustrated in FIGS. 6 and 8, the controller 50 may be configured to provide a digital output that provides an encrypted data stream in which encoded sensor output is in millivolts, and includes the sensor date of manufacture and serial number. Other data may include, for example, diagnostic and exposure history information. Diagnostic information may include, for example, notification to the user/host of rapid changes in oxygen concentration that would be beyond the capabilities of a sensor operating properly. Exposure history information may include, for example, data logging and notification to the user/host of exposure to oxygen partial pressures at or beyond the absolute maximum limits/rating of the device.

As set forth in FIGS. 5-10, the controller 50 and A/D converter may be in communication with the host system 100 to receive information from the controller 50 and, optionally, to display the remaining life of the sensor 10 as the anode 4 is consumed. The host system 100 may, but need not, display the information received from the controller 50 visually. As illustrated, the host system 100 may be any system capable of receiving data from the controller 50, such as a personal computer (FIGS. 5-9) or a stand-alone handheld device (FIG. 10), as known to those of skill in the art. The host system 100 may include an input device 122, such as a keyboard, and a display 120, such as a computer screen or monitor, coupled to the controller 50. When present, the display 120 may be any device suitable for displaying the data processed from the controller 50, such as, for example, light-emitting diodes (LEDs), LED pixel displays, liquid crystal displays (LCDs), raster displays, neon digit displays, and electronic ink.

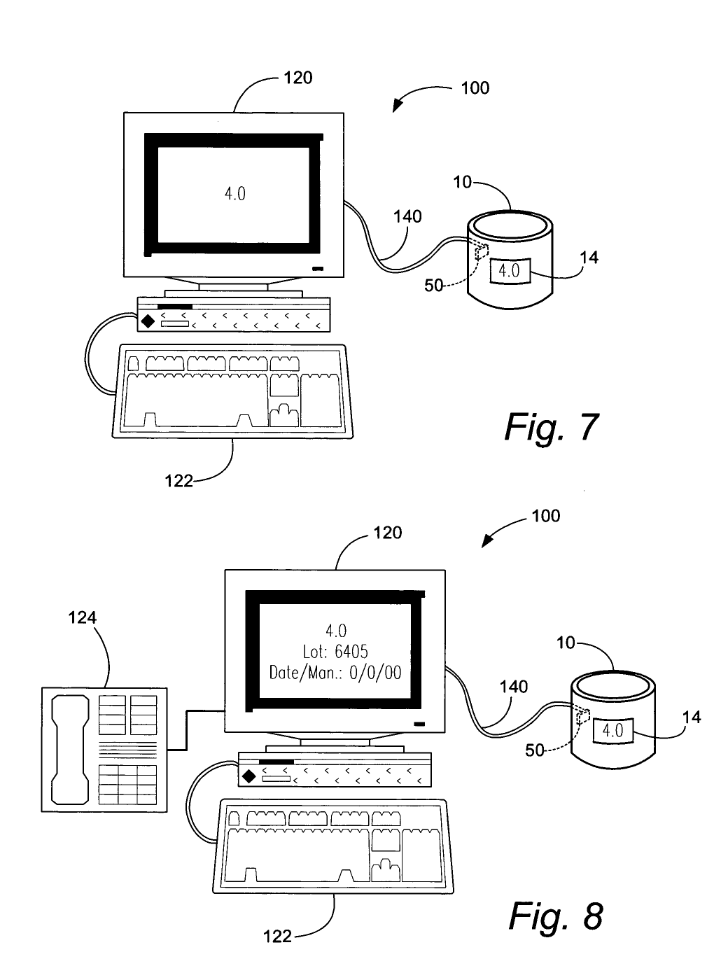

As illustrated in FIGS. 7 and 8, embodiments of the present invention may include a display 14 localized on the gas sensor 10, either alone or in addition to the display 120. Although illustrated on the external wall of the sensor 10, the display 14 may be positioned at any location on or near the sensor 10 for convenient display. The display 14, if present, may be any type of display known to those of skill in the art, such as, for example, those displays set forth herein. When both display 120 and display 14 are present, displays 14, 120 may be the same or different type of display.

As shown in FIG. 8, the host system 100 may also be configured to include an external communication port 124 to connect to the internet to retrieve or transmit information, such as, for example, from or to the manufacturer's website. The connection to the internet may be made either automatically or upon request by the user.

The input device 122 may be employed to input information in addition to, or as a substitute for, the data output that could be provided by the controller 50. The input device 122 allows the user to manually input information into the host system 100 for use, such as for display or for processing by the host system 100.

The gas sensor 10 and system of the present invention provide an approach to continually or intermittently monitor the oxygen and process the cumulative oxygen exposure of the sensor 10, through the measurement of cumulative sensor output, in order to obtain an accurate and reliable estimate of the remaining life of the sensor 10. This data stream, along with, optionally, other relevant sensor data, can be transmitted to the host system 100 for display, to track sensor maintenance for consistency from sensor to sensor, to reduce replacement costs by avoiding premature replacement, to normalize the analog output within standard ranges, and/or to avoid extended periods of process downtime as a result of the anode being consumed at inconvenient or unexpected times. The data stream may be encrypted to provide an additional measure of safety to prevent, for example, machine tampering and unauthorized parts substitution.

It is contemplated that many other functions or features well know to those of skill in the art can be incorporated into the gas sensor 10 and system of the present invention. For example, various alarms or warning signals known to those of ordinary skill in the art can be included into the system that provide audio or visual notice to the user that the counter on the display(s) 14, 120 is at or near zero. Furthermore, embodiments of the present invention may include diagnostic equipment that eliminates or normalizes abnormal measurement spikes. Also, other data output known to those of skill in the art, but not specifically set forth herein, can be measured, monitored, and/or displayed.

The sensor 10 of the present invention may be employed with various gas monitoring systems known to those of skill in the art. For example, a non-exhaustive list of suitable measurement systems that may employ the sensor 10 of the present invention include gas preparation and validation equipment, such as underwater diving apparatus, medical gas delivery equipment, automobile test equipment, and the like.

Accordingly, although the foregoing description has necessarily presented a limited number of embodiments of the invention, those of ordinary skill in the relevant art will appreciate that various changes in the configurations, details, materials, and arrangement of the elements that have been herein described and illustrated in order to explain the nature of the invention may be made by those skilled in the art, and all such modifications will remain within the principle and scope of the invention as expressed herein in the claims. In addition, although the foregoing detailed description has been directed to an embodiment of the gas sensor of the invention in the form of an oxygen sensor, it will be understood that the present invention has broader applicability and, for example, may be used in connection with all gas sensors. All such additional applications of the invention remain within the principle and scope of the invention as embodied in the claims.

1. A gas sensor, comprising:
a housing including a cavity, the housing including an anode within the cavity; and
a controller in communication with the anode and configured to measure sensor current output.

2. The gas sensor of claim 1, wherein the controller is further configured to determine the remaining life of the sensor.

3. The gas sensor of claim 1, wherein the controller is configured to subtract a cumulative current output of the sensor from a theoretical total to determine the remaining life of the sensor.

4. The sensor of claim 1, wherein the controller is configured to communicate the sensor current output in encrypted format.

5. The sensor of claim 1, wherein the controller is further configured to communicate sensor data output selected from the group consisting of date of manufacture, serial number, diagnostic information, and exposure history information of the gas sensor.

6. The gas sensor of claim 1, wherein the controller is a microcontroller positioned within the housing of the sensor.

7. The gas sensor of claim 1, further comprising an analog to digital converter in communication with the controller.

8. The gas sensor of claim 7, further comprising a display in communication with the analog to digital converter and configured to display the remaining life of the sensor.

9. The sensor of claim 8, wherein the display is selected from the group consisting of a light-emitting diode display, light-emitting diode pixel display, liquid crystal display, raster display, neon digit display, and electronic ink.

10. The sensor of claim 1, wherein the controller is coupled to a host system.

11. The sensor of claim 10, wherein the host system is configured to display the remaining life of the sensor.

12. A gas sensor, comprising:
a housing including a cavity, the housing including an anode within the cavity;
a controller in communication with the anode and configured to measure sensor current output and determine the remaining life of the sensor;
an analog to digital converter in communication with the controller; and
a display in communication with the analog to digital converter and configured to display the remaining life of the sensor.

13. The gas sensor of claim 12, wherein the controller is configured to subtract a cumulative current output of the sensor from a theoretical total to determine the remaining life of the sensor.

14. The sensor of claim 12, wherein the controller is configured to communicate the sensor current output in encrypted format.

15. The sensor of claim 14, wherein the controller is further configured to communicate sensor data output selected from the group consisting of date of manufacture, serial number, diagnostic information, and exposure history information of the gas sensor.

16. The gas sensor of claim 12, wherein the controller is a microcontroller positioned within the housing of the sensor.

17. The sensor of claim 12, wherein the display is selected from the group consisting of a light-emitting diode display, light-emitting diode pixel display, liquid crystal display, raster display, neon digit display, and electronic ink.

18. The sensor of claim 12, wherein the controller is coupled to a host system.

19. The sensor of claim 18, wherein the host system is configured to display the remaining life of the sensor.

20. A gas sensor, comprising:
a housing including a cavity, the housing including an anode within the cavity; and
means for measuring sensor current output at the anode and determining the remaining life of the sensor.

21. A system for determining the remaining life of a gas sensor, comprising:
a housing including a cavity, the housing including an anode within the cavity;
a controller in communication with the anode and configured to measure sensor current output; and
a host system in communication with the controller and configured to receive data output from the controller.

22. The system of claim 21, wherein the controller is further configured to determine the remaining life of the sensor, at least one of the sensor and the host system is configured to display the remaining life of the sensor.

23. The gas sensor of claim 21, wherein the controller is configured to subtract a cumulative current output of the sensor from a theoretical total to determine the remaining life of the sensor.

24. The sensor of claim 21, wherein the controller is configured to communicate the sensor current output in encrypted format.

25. The sensor of claim 21, wherein the controller is further configured to communicate sensor data output selected from the group consisting of date of manufacture, serial number, diagnostic information, and exposure history information of the gas sensor.

26. The gas sensor of claim 21, wherein the controller is a microcontroller positioned within the housing of the sensor.

27. The sensor of claim 21, wherein the display is selected from the group consisting of a light-emitting diode display, light-emitting diode pixel display, liquid crystal display, raster display, neon digit display, and electronic ink.

28. A method of determining the remaining life of a gas sensor, comprising:
measuring sensor current output by a controller;
subtracting a cumulative current output of the sensor from a theoretical total to determine the remaining life of the sensor.

29. The method of claim 28, further comprising communicating the sensor current output in encrypted format.

30. The method of claim 28, further comprising communicating at least one of remaining life, date of manufacture, serial number, diagnostic information, and exposure history information of the gas sensor.

31. The method of claim 30, further comprising displaying at least one of remaining life, date of manufacture, serial number, diagnostic information, and exposure history information of the gas sensor.
